(19) United States
(12) Patent Application Publication
(10) Pub. No.: US 2020/0329837 A1
(43) Pub. Date: Oct. 22, 2020

(54) STACKABLE BOX

(71) Applicants: ROTHENBERGER AG, Kelkheim (DE); Plaston AG, Widnau (CH)

(72) Inventor: Rolf BURCHIA, Widnau (CH)

(73) Assignees: ROTHENBERGER AG, Kelkheim (DE); Plaston AG, Widnau (CH)

(21) Appl. No.: 16/921,216

(22) Filed: Jul. 6, 2020

Related U.S. Application Data
(63) Continuation of application No. 15/747,865, filed on Jan. 26, 2018, now Pat. No. 10,750,833.

(30) Foreign Application Priority Data
Aug. 18, 2015 (DE) 20 2015 005 752.7

(51) Int. Cl. A45C 5/03; B25H 3/02; B65D 21/02

(52) U.S. Cl. CPC A45C 5/03; B25H 3/02; A45C 2005/037; B65D 21/0223; B25H 3/027

(57) ABSTRACT

A stackable box includes a lower part, a first foot strip arranged on an underside of the lower part, a first projection extending from the first foot strip, a second foot strip arranged on the underside of the lower part, a second projection extending from the second foot strip, a lid, a first coupling part arranged on the lid directly above the first projection, and a second coupling part arranged on the lid directly above the second projection. The stackable box has a front and a rear, a distance from the front to the rear defining a longitudinal length of the box. The lid may include a first receiving region proximal to the first coupling part. The first receiving region has a longitudinal length which is greater than a longitudinal extension of the first foot strip. The first receiving region may be arranged in front of the first coupling part.

### TECHNICAL FIELD

The disclosure relates to a box for stacking with a further box. The disclosure further relates to an arrangement comprising at least two boxes stacked one on top of the other. Furthermore, the disclosure relates to a method for stacking at least two boxes.

### BACKGROUND

Boxes serve for transport and/or storage of objects, for example tools. The boxes can be configured to be stackable, so that multiple boxes can be stacked one on top of the other. Such boxes generally have fastening means for holding a stacked-on box in place.

The present disclosure provides a solution which makes stacking a box on top of another box and securing them to one another in the stacked state easier.

### SUMMARY

A box for stacking with a further box is provided. The box has a contact surface for stacking the further box, and at least one coupling part, which can be brought together with a counter-coupling part of the further box, forming a plug-in connection. The coupling part is aligned in such a manner that the plug-in connection with the counter-coupling part is formed by displacement of the further box along the contact surface.

Furthermore, the box has at least one locking element for securing the plug-in connection to prevent release, in particular random release. In particular, the locking element is mounted on the box in movable manner, particularly fastened onto the box or formed on it, for example molded onto it. It is provided that the locking element can be moved from an initial position into an intermediate or end position, in particular compulsorily moved, and in the initial position, is situated in a receiving region for the further box, wherein the receiving region is used during or for setting of the further box onto the contact surface.

In such a box, stacking of the further box can take place so that it is easy to operate and handle, and fastening of the stacked-on further box can be implemented so that it is easy to operate and handle. This is because a coupling connection of the box with the further box can be achieved by the coupling part that is provided for forming a plug-in connection, by simple insertion or pinning of the coupling part into or onto the counter-coupling part of the further box. Formation of the plug-in connection is facilitated by the special configuration of the coupling part, and this supports its ease of operation and handling. This is because it is permitted, in particular exclusively permitted, for the plug-in connection of the coupling part with the counter-coupling part to be achieved by means of a targeted movement, in particular a guided movement, namely by displacement of the further box along the contact surface. The coupling part can be a plug-in holder. In this regard, the counter-coupling part can be a plug-in element that preferably corresponds to the plug-in holder, which can be inserted into the plug-in holder. Also, vice versa, the coupling part can be a plug-in element and the counter-coupling part can form the plug-in holder for the plug-in element.

By means of the locking element provided, it is possible to effectively secure the plug-in connection of the coupling part with the counter-coupling part of the further box to prevent them from coming apart, in particularly from being pulled apart counter to the interlocking direction. In that the locking element is present in the initial position in the receiving region for the further box, the result is achieved that the further box comes into contact with the locking element, and activates the locking element and thereby brings about a movement of the locking element when the further box performs a set-down movement in the direction toward the contact surface, and gets into the receiving region during this process. As a result, the set-down movement performed by the further box is also used for activation of the locking element. Separate manual activation by an operator is not required. This measure, too, is therefore aimed at supporting ease of operation and handling.

In technically simple manner, contacting of the locking element with the further box can be achieved during the course of its set-down movement, if the locking element projects beyond a bottom surface of the receiving region in the initial position and/or if the locking element extends beyond the bottom surface in the initial position and/or if the locking element is present elevated relative to a bottom surface of the receiving region in the initial position.

For example, it is provided that in the initial position, the locking element projects beyond a bottom surface of the receiving region with one end, and in the intermediate or end position, the one end of the locking element is set back downward as compared with the initial position. In the intermediate or end position, the locking element is then brought outside of the receiving region, for example, and thereby setting the further box onto the contact surface and/or displacing the set-down further box to form the plug-in connection is made possible.

It can be provided that the bottom surface of the receiving region forms at least a part of the contact surface. As a result, the receiving region serves as a region in which the further box is set down.

According to one embodiment the locking element can be moved in spring-loaded manner. As a result, the energy from a movement of the locking element can be stored in technically simple manner.

For example, the locking element can be moved from the initial position into the intermediate or end position counter to a spring force. As a result, the locking element is automatically moved back from the intermediate or end position in the direction of the initial position and/or into the initial position by the spring force. This measure, too, supports the ease of operation and handling.

The locking element may be held in the initial position in spring-loaded manner. As a result, the locking element is held in the initial position under spring pre-tension. As a result, possible undesirable wiggling of the locking element in the initial position is counteracted.

In order to be able to displace the locking element under spring stress, a spring element, for example, or another force storage unit is provided. A pressure spring can be used. Also, elastomer springs, leaf springs, helical springs or springs of a general nature can be used. Likewise, torsion springs or plate springs can be used.

According to one embodiment, the locking element is configured as a locking slider, which can be displaced from the initial position into the intermediate or end position, in particular displaced in translational manner. Such a locking element can be implemented in technically relatively simple manner.

The locking element, which is configured as a locking slider, can have or consist of a holding part or bottom part disposed fixed in place on the housing with reference to the box, and a sliding part mounted movably on that, in particular a sliding bolt. The holding part is disposed on the box, in particular attached to it or configured on it, such as formed onto it or formed out of it, for example.

The locking slider can be implemented in technically simple manner if the holding part and the sliding part are configured to be U-shaped in cross-section, and are nested into one another, in opposite directions relative to one another, wherein a pressure spring is disposed between the shanks of the parts, which spring supports itself against a bottom surface of the one holding part, on the one hand, and against a bottom surface of the slider part, on the other hand. In this embodiment of the locking slider, a guided movement of the sliding part relative to the holding part is guaranteed in simple manner by means of the shanks of the holding part and of the sliding part.

It is useful if the slider part is displaceable relative to the holding part with a stop restriction. In this way, it is guaranteed that the displacement movement of the locking slider takes place within predetermined limits and remains within them.

According to a first embodiment, the locking element is configured as a pivot lever, which can be pivoted from the initial position into the intermediate or end position about a pivot axle, in particular a pivot axle fixed in place on the housing. Also, the locking element can be configured as a rotating lever, which can be rotated from the initial position into the intermediate or end position about a rotation axle, in particular a rotation axle fixed in place on the housing. Fundamentally, it is also possible that the locking element has a rotating closure or is formed by a rotating closure, which can be rotated from the initial position into the intermediate or end position relative to a base part, in particular a base part fixed in place on the housing, for rotation.

According to a possible embodiment, the box has a top, a bottom, a front side, and a rear side, wherein the expanse of the box from the front side to the rear side forms a longitudinal expanse. In particular, the top and the bottom lie opposite one another, and may form flat sides or surface sides. In particular, the front side and the rear side lie opposite one another and may form narrow sides. In particular, the top and the bottom are disposed to lie transversely relative to the front side and the rear side, in particular disposed to lie at a right angle relative to one another.

According to one embodiment, the contact surface is assigned to the top and a carrying handle is disposed on the front side of the box, so that when the box is carried by the carrying handle, the rear side faces downward. The box is thereby set upright when the box is held by the carrying handle. The coupling part of the box and the counter-coupling part of the further box must then be engaged into one another to form the plug-in connection, since the contact surface is present as a side surface that lies laterally. In this regard, the plug-in connection forms an engagement connection.

For example, it is provided that the engagement connection is formed by an engagement projection having an engagement opening and an engagement tab, for example in the form of a lobe, which can be brought into engagement with the engagement opening. The coupling part can form the engagement projection and the counter-coupling part can form the engagement tab. Also, the coupling part can form the engagement tab and the counter-coupling part can form the engagement projection.

The engagement tab can be beveled. Also, the engagement opening or the engagement projection can have at least one introduction bevel, in order to allow an engagement connection between the boxes or box surfaces that are assigned to one another, which connection is secured to prevent displacement and is relatively free of play.

A possible embodiment of the invention consists in that box has a lower part and a lid disposed on the former so as to pivot, wherein the top of the box is formed by the bottom of the lid, and the bottom of the box is formed by the bottom of the lower part, and the carrying handle is disposed on the lower part. The locking element may then be assigned to the lid.

In a further embodiment the coupling part is directed in the direction toward the carrying handle, so that the plug-in connection with the counter-coupling part of the further box is formed by displacement of the further box away from the front side, in the direction toward the rear side of the box. In this way, the plug-in connection supports coupling of the box with the further box when the box is carried by the carrying handle, since the weight force of the further box acts on the coupling part of the box in the plug-in direction. This is because the weight force acts in the plug-in direction, which is directed in the direction away from the carrying handle, toward the rear side of the box.

According to a further embodiment of the invention, it is provided that the receiving region for the further box is assigned to the top, and the locking element is disposed in the region of the front side and projects beyond the top in the initial position.

It is useful if the top of the box has at least one cross-rib, which runs transversely relative to the longitudinal expanse of the box and has a side surface that stands outward and faces the front side. The side surface can be used as a stop for the further box, for example when the box is held by its carrying handle and thereby the top of the box lies set up on the side, because of its upright position. In this case, the further box can then support itself against the side surface of the cross-rib with a counter-surface, so that the plug-in connection between the coupling part and the counter-coupling part is relieved of stress, in terms of force, in this way.

The coupling part may be fastened to or formed on the cross-rib. In this way, the stability of the coupling part itself is improved, since forces that act on the coupling part are absorbed by the cross-rib.

The top of the box may have two cross-ribs that each run transversely relative to the longitudinal expanse of the box and have a side surface that stands outward and faces the front side, wherein the cross-ribs delimit a cross-groove that runs between them. This measure is also aimed at being able to absorb a weight force of the further box that acts on the box, and of relieving stress on the plug-in connection when the box is being carried by the carrying handle. This is because two side surfaces are made available by the two cross-ribs, on which the further box can support itself with a corresponding counter-surface, in each instance.

Also, great stability exists if, for example, the box were to be carried in the opposite direction, in which the carrying handle then faces downward. This is because a projection of the further box can be brought into engagement by the cross-groove provided, so that the further box supports itself against the box not only when the carrying handle faces downward but also when the carrying handle faces upward.

It is useful to configure the bottom of the box corresponding to its top, so that the box, with its bottom, can be stacked onto another box that has a top configured corresponding to the box. In particular, the bottom of the box is configured corresponding to the bottom of the further box. In this way, stacking of any desired number of boxes can be implemented in simple manner, since for this purpose, the boxes are configured as the same parts and thereby stacking of the boxes toward the bottom and toward the top can take place, proceeding from a reference box, for example.

For reasons of stability, two coupling parts are provided according to a further embodiment, which parts can each be brought together with a related counter-coupling part of the further box, forming a plug-in connection, and are oriented in such a manner that the plug-in connection with the counter-coupling part is formed by displacement of the further box along the contact surface, wherein the coupling parts are disposed to lie next to one another with reference to the insertion direction or plug-in direction, for production of the plug-in connection.

The measure according to which, according to a further embodiment of the invention, at least one further coupling part is provided, which can be brought into a plug-in connection with a related counter-coupling part of the further boxes, forming a plug-in connection, and is oriented in such a manner that the plug-in connection with the counter-coupling is formed by means of displacement of the further box along the contact surface, aims in the same direction, wherein the further coupling part and the coupling part are configured to lie one behind the other with reference to the insertion direction, for production of the plug-in connection.

For example, the coupling part is disposed in the region of the edge of the top that faces the front side. For example, the further coupling part is disposed in the region of the edge of the top that faces the rear side. Also, the coupling part and/or the further coupling part can be disposed in a central region of the top of the box.

The one locking element can be provided exclusively. Also, the locking element can be produced multiple times. In this case, the locking elements can be disposed to lie one behind the other transversely to the longitudinal direction of the box.

The at least one locking element can be integrated into the box itself, for example end or be flush with the outer surfaces of the box, or lie or end behind them. Also, it can be provided that the at least one locking element is present as a separate part and, in particular, is connected with the related box surfaces in one or multiple pieces, in terms of material. Furthermore, the locking element, as a separate part or module, can be connected with an outer wall of the box. In this way, subsequent retrofitting of a box with the locking element is facilitated.

According to a further embodiment, an arrangement comprising at least two boxes stacked one on top of the other, of which at least one of the boxes has a contact surface and at least one coupling part, wherein the other box is set onto the contact surface and the coupling part forms a plug-in connection with a counter-coupling part of the other box, which connection is formed by displacement of the other box along and/or on the contact surface. Furthermore, at least one locking element is provided, which is present in a locking position that secures the plug-in connection to prevent loosening, in particular random loosening. In the locking position, the locking element is situated in a receiving region for the other box, which region is used when the other box is set onto the contact surface. For example, by setting the other box onto the contact surface, the locking element is or was moved from the locking position into a unlocking position with regard to securing of the plug-in connection and/or into a release position, in which pushing the boxes together to form the plug-in connection between the boxes is permitted. The locking position can be an initial position, for example the initial position described above.

The at least one box having the contact surface and the at least one coupling part can be the box described above. The box of the arrangement that is stacked on top of it can be the further box described above. For this case, the locking position corresponds to the initial position of the box described above and/or the release position corresponds to the intermediate or end position described above.

For example, on the box that is set on, a surface or a surface section is used or can be used as a stop surface, which is brought or can be brought into contact against the locking element in the locking position of the locking element. The stop surface can be provided on a face side, for example the front side of the stacked box, in particular configured there. The stop surface can also be formed by means of a setback surface or a surface provided with an introduction bevel, in order to thereby achieve an additional pre-tension of the locking element towards the plug-in connection or engagement connection between the stacked boxes.

The locking element can have an essentially rectangular profile, in order to secure the plug-in connection between the coupling part and the counter-coupling part with some play, so that the coupling part and the counter-coupling part still have some movement play relative to one another when the plug-in connection has been formed, for example a play in the plug-in direction of about 1 to 2 mm, for example, is present, without the plug-in connection coming apart, for example being manually uncoupled.

It can furthermore be provided that the locking element itself or the stop surface against which the locking element lies in the locking position or which can be used as a stop is configured in wedge shape, so that the locking element additionally pre-tenses the plug-in connection in the plug-in direction or insertion direction, and secures the movement of the two stacked boxes in the plug-in direction, relative to one another.

The disclosure also relates to a method for stacking at least two boxes. At least one of the boxes can be the box described above. Also, the two boxes, in particular all the boxes can be formed by the box described above.

In the method, one of the boxes is set onto a contact surface of the other box and subsequently, the box is pushed along the contact surface, over a displacement path, into a plug-in connection with the other box, wherein a locking element is activated by setting the box onto the other box, in that the box moves the locking element from an initial position into an intermediate or end position. In the initial position, the locking element is situated in a blocking position or blocking position, in which the locking element engages into the displacement path for the further box. In the intermediate or end position, the locking element is situated in a release position or release position, in which the locking element opens up the displacement path.

In this way, the result is achieved that the box comes into contact with the locking element and activates the locking element, and thereby brings about a movement of the locking element when the box performs a set-down movement in the direction toward the contact surface and gets into the receiving region when doing so. Thereby the set-down movement performed by the box is also used for activation of the locking element. Separate manual activation by an operator is eliminated. As a result, advantages occur with regard to operation and handling.

Furthermore, the disclosure relates to a use of the box described above for transport and/or for storage of tools and/or craftsmen's material.

Within the course of the invention, the term “box” should be understood within broad limits. In particular, the box is a container. The box can be a container, for example, that is closed on all sides and provided with a lid. The lid can be disposed on the container so as to pivot. Also, the container and the lid can be present without such a connection. The box that can be set onto the box can be configured in the same manner. Also, it is possible that the box that can be set on is configured as a half-open shell or as a plate, in particular as an adapter plate.

The box is particularly suitable for transporting and/or storing objects. For example, the box is a tool case that serves or can be used for storage and/or for transport of tools, material and/or equipment.

With the disclosed boxes it is possible that two boxes that are stacked one on top of the other are brought into a coupling connection, for example a plug-in connection or an engagement connection. Then, the bottom surface of the upper box is set onto the cover surface of the lower box, and a displacement of the two boxes in an engagement connection or coupling between the two boxes is produced. Securing of the plug-in connection or coupling connection can take place by at least one locking element, such as, for example, a spring-loaded locking slider, which is disposed on the lower box, for example, and which can be activated by the bottom surface of the upper box. It can furthermore be implemented that after activation has taken place, the locking element comes to lie against a stop surface of the upper box and thereby secures the engagement connection or plug-in connection between the two boxes to prevent unintentional release.

The locking element may be disposed in the front region of the lower box, in each instance, and, for example, it can be configured by a locking element that can be pushed out of the top or cover surface, in such a manner that the locking element lies against a related stop surface on the box that lies on top, in a locking position or in a securing state, and provides security to prevent uncoupling of the one box relative to the other box. To release this secured engagement connection or plug-in connection, the locking element can be activated manually, in order to bring the locking element from the initial position or locking position or securing position into an intermediate or end position and/or unlocking position and/or opening position, and to thereby bring it out of engagement with the related stop surface on the opposite box part.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows a stackable box in a perspective representation from above.

FIG. 2 shows the box according to FIG. 1 in a perspective representation from below.

FIG. 3 shows a modification of the box according to FIGS. 1 and 2, on which a further box is stacked, in a first assembly state with regard to stacking, shown in a sectional representation of the two boxes.

FIG. 4 shows the two boxes according to FIG. 3 in a second assembly state, in which the further box is stacked on the box.

FIG. 5 shows the two boxes according to FIG. 3 in a third assembly state, in which the further box is stacked on the box and brought into a fastening position against the box.

FIG. 6 is a schematic representation of a locking principle, as shown in FIGS. 3 to 5.

FIG. 7 shows the locking principle according to FIG. 6 in the locked state.

FIG. 8 shows a further possible embodiment of a stackable box having a locking element configured as a pivot lever, in a schematic representation.

FIG. 9 shows a further possible embodiment of a box onto which a further box is stacked, in a first assembly state with regard to stacking, shown in a sectional representation of the two boxes.

### DETAILED DESCRIPTION

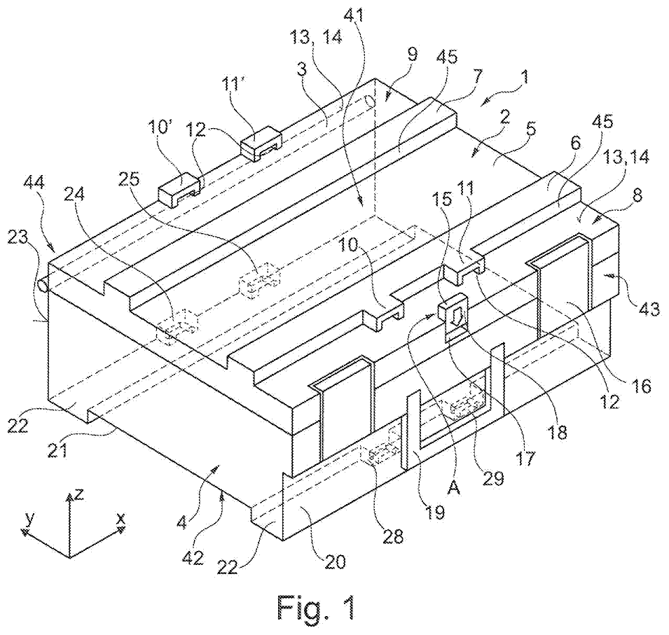

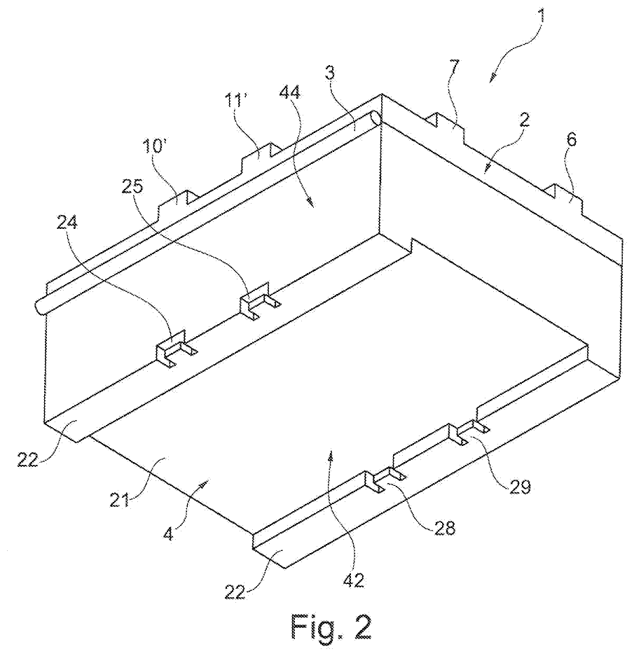

FIGS. 1 and 2, in a schematic representation, show a possible embodiment of a stackable box 1 in a perspective view from above (FIG. 1) and in a perspective view from below (FIG. 2). The box 1 can be used for transporting and/or storing objects. For example, the box 1 is a tool case, which serves for transporting and/or storing tools and/or material and/or equipment of a craftsman or technician, for example.

The box 1 has a top 41, a bottom 42, a front side 43, and a rear side 44. Preferably, the expanse of the box 1 from the front side 43 to the rear side 44 forms a longitudinal expanse, which is also indicated as the Y direction in FIG. 1. Preferably, the expanse of the box 1 from the bottom 42 to the top 41 forms a height expanse, which is indicated as the Z direction in FIG. 1. The expanse of the box 1 transversely to the longitudinal expanse is indicated as the X direction in FIG. 1.

Preferably, the box 1 has a lid 2 and a lower part 4 that can be covered by the lid 2. Preferably, the top 41 of the box 1 is formed by the top of the lid 2, and the bottom 42 of the box 1 is formed by the bottom of the lower part 4. The lid 2 can be connected with the lower part 2 so as to pivot, for example can be mounted on the lower part 4, so as to pivot, by way of a hinge axle 3, particularly a horizontal axle, which is assigned to the rear side 44, for example. In order to secure the lid 2 to prevent unintentional opening relative to the lower part 4, closure elements 16, such as closure latches, for example, can be provided. Preferably, the closure elements 16 are assigned to the front side 43.

Preferably, the box 1 has a carrying handle 19. Preferably, the carrying handle 19 is disposed on the front side 19, so that when the box 1 is carried by the carrying handle 19, the rear side 44 faces downward. Preferably, the carrying handle 19 is mounted on the front side 43 so as to pivot. The carrying handle 19 can be assigned to the lower part 4 or to the lid 2, in particular disposed on it. The box 1 can have a contact surface on the front side 43, against which the carrying handle 19 is laid or can be laid. Preferably, the contact surface is offset toward the rear in the Y direction. At least one further carrying handle may be provided, which is assigned to the top 41, for example.

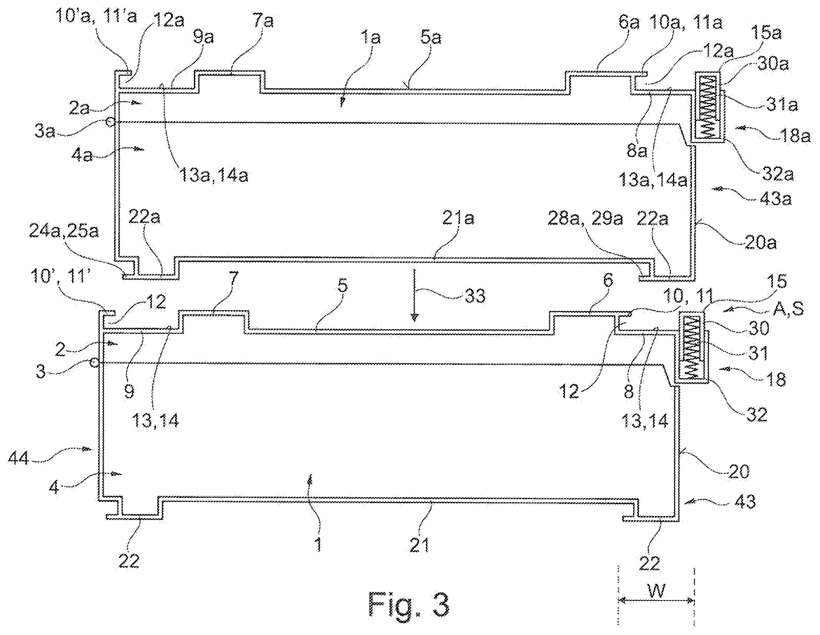

The box 1 is suitable for stacking with at least one further box. For this purpose, the box 1 has a contact surface 13 for the further box and at least one, preferably at least two coupling parts 10, 11, which can be brought together with a related counter-coupling part of the further box, in each instance, forming a plug-in connection. FIG. 3 shows a further box 1a, as an example, which can be stacked onto the box 1. The further box 1a has at least two counter-coupling parts 28a, 29a, which can be brought together with the coupling part 10, 11 of the box 1, forming a plug-in connection. During the course of the further description of the box 1 with regard to the functions provided for stacking of a further box, the box 1a of FIG. 3 will already be referred to hereinafter. In the case of the box 1, it is provided that the plug-in connection with the further box 1a can only be carried out after the further box 1a has been set onto the contact surface 13. For this purpose, the coupling parts 10, 11 are oriented in such a manner that the plug-in connection with the counter-coupling part 28a or 29a, in each instance, is formed by means of displacement of the further box 1a along and/or on the contact surface 13.

Preferably, the coupling parts 10, 11 are oriented in the longitudinal direction or the Y direction in such a manner that the plug-in connection is formed by means of displacement of the further box 1a away from the front side 43, in the direction toward the rear side 44 of the box 1. For example, the coupling parts 10, 11 are configured as a plug-in holder, and the counter-coupling elements 28a, 29a are configured as a plug-in element, which can be inserted into the related plug-in holder through a plug-in opening 12. For example, the plug-in holder forms an engagement lug, and the plug-in element forms an engagement tab, which can be engaged against the engagement lug through the plug-in opening 12 that is configured as an engagement opening. For example, the engagement tab is formed by a lug or tab that projects outward on one side.

Preferably, the plug-in elements or engagement tabs are configured to run in wedge shape in the insertion direction, so that the plug-in elements can be inserted into the related plug-in holders without play, and therefore the plug-in connection is secured to prevent displacement in the X direction and Y direction. Preferably, the plug-in holders or engagement lugs are profiled in wedge shape, corresponding to the plug-in elements. Furthermore, the respective plug-in element and the related plug-in holders are secured, relative to one another, to prevent them from being lifted off in the Z direction.

Preferably, the contact surface 13 is assigned to the top 41, in particular configured on the top 41. Preferably, the coupling parts 10, 11 are assigned to the top 41, in particular configured on the top 41. Preferably, the box 1 has at least one, preferably two cross-ribs 6, 7 on the top 41, which ribs run transversely to the longitudinal expanse of the box 1, in each instance, in particular in the X direction, and each have a side surface 45 that projects outward and faces the front side 43.

Preferably, the cross-ribs 6, 7 delimit a cross-groove 5 that runs between them. For example, the lid 2 has an essentially flat part on its top, which part has the cross-groove 5 in its center region and is delimited laterally by the cross-ribs 6, 7, which are configured to be elevated. By means of the cross-groove 5, a further box, which is configured to be shorter in the longitudinal direction as compared with the box 1a, can be stacked on, wherein then, the further box can engage into or support itself in the cross-groove 5 and/or against the side surface 45 of the cross-rib 7 with its rear end, which faces the rear side 44 of the box 1.

Preferably, the coupling parts 10, 11 are spaced apart from one another in the transverse direction or X direction. Preferably, the coupling parts 10, 11 are each connected with the cross-rib 6 or formed onto the cross-rib 6. Preferably, two further coupling parts 10′, 11′ are provided, which can each be brought together with a related further counter-coupling part 24a or 25a of the further box 1a, forming a plug-in connection, and are oriented in such a manner that the plug-in connection with the related counter-coupling part 24a or 25a is formed by means of displacement of the further box 1a along and/or on the contact surface 13. Preferably, the further coupling parts 10′, 11′ and the coupling parts 10, 11 are disposed to lie one behind the other with reference to the insertion direction for production of the plug-in connection, in other words in the Y direction.

Preferably, the coupling parts 10, 11 are disposed to border on a receiving region 8 for the further box 1a, in particularly to border on the receiving region 8 in the Y direction. Preferably, the further coupling parts 10′, 11′ are disposed to border on the further receiving region 9 for the further box 1a, in particular to border on the further receiving region 9 in the Y direction. Preferably, the receiving region 8 is disposed on the top 41 in the front region, which is situated in the edge region toward the front side 43, for example. Preferably, the further receiving region 9 is disposed on the top 41 in the rear region, which is situated in the edge region toward the rear side 44, for example.

Preferably, the further box 1a has a corresponding foot strip 22a, in each instance, which extends in the transverse direction or X direction, for example, and projects downward, in order to be held in the receiving region 8 and the further receiving region 9. The foot strip 22a can project so far downward, in each instance, that the further box 1a is set down onto the bottom surface 14 of the receiving regions 8 and 9 by way of the foot strips 22a. The bottom surface 14 then forms the contact surface 13. Alternatively, the foot strip 22a can project so far downward, in each instance, that the further box 1a is set down onto the cross-ribs 6, 7, and the foot strips 22a lie at a distance from the bottom surface 14 of the receiving regions 8 and 9 or also are set down on the bottom surface 14 of the receiving regions 8 and 9. In this case, the top of the cross-ribs 6, 7 forms a contact surface for the further box 1a, at least in part.

Preferably, the foot strips 22a run transversely relative to the longitudinal expanse of the further box 1a, and delimit a setback 21a that lies between them and is configured as a groove that runs transversely, for example. The setback 21a is provided for holding the cross-ribs 6, 7 of the box 1, for example. Preferably, the foot strips 22a end approximately with the rear wall 23a and the front side 43a of the further box 1a. Preferably, the foot strips 22a are configured to be continuous. Fundamentally, the foot strips 22a can also be present only in pieces, or can be eliminated entirely.

Preferably, the bottom 42 of the box 1 is configured in accordance with the bottom of the box 1a, so that the box 1 itself can be used for being stacked on top of a box. Preferably, for this purpose the bottom 42 of the box 1 is structured to correspond to its top 41. Preferably, for this purpose at least individual components described with reference to the further box 1a, namely the counter-coupling parts 28a, 29a, the further counter-coupling parts 24a, 25a, the setback 21a, and the rear wall 23a are provided on the box 1 as counter-coupling parts 28, 29, further counter-coupling parts 24, 25, setback 21, and rear wall 23.

Furthermore, the box 1 has at least one locking element 18 for securing the plug-in connection that can be formed by the coupling parts 10, 11 and the counter-coupling parts 28a, 29a, to prevent it from coming loose. The locking element 18 can be moved from an initial position A or rest position, which is shown in FIG. 1, into an intermediate or end position, and is situated in the initial position A in the receiving region 8 for the further box 1a. As a result, it is possible that the locking element 18 is activated by the further box 1a when the further box 1a is set onto the contact surface 13. For this purpose, it is preferably provided that the locking element 18 projects beyond the bottom surface 14 of the receiving region 8 in the initial position A, with an end 15. Preferably, in the intermediate or end position, the end 15 is lowered related to the initial position A.

Preferably, the locking element 18 is assigned to the top 41 and disposed in the region of the front side 43 of the box 1, for example of the lid 2. For example, the locking element 18 is disposed in a recess 17 on the front side 43.

Preferably, the locking element 18 can be moved in spring-loaded manner. For example, the locking element 18 can be moved from the initial position A into the intermediate or end position counter to a spring force, so that the locking element 18 automatically moves back from the intermediate or end position into the initial position A by means of spring force.

FIG. 3 shows a modification of the box 1 in a sectional representation. As is evident from this, the locking element 18 can be configured as a locking slider, which can be displaced from the initial position A into the intermediate or end position. For this purpose, a holding part 32 or bottom part can be provided, which is assigned to the lid 2, in particular connected with it or formed from it. The holding part 32 can be profiled in U shape or configured in cup shape, and a pressure spring 31 can be disposed in its recess that opens upward. The pressure spring 31 can support itself on the inside of a sliding part 30, in particular a sliding latch, which is guided on the holding part 32 so as to be displaceable.

Preferably, stops are present, in order to prevent the sliding part 30 from being pushed out of the U-shaped profiled holding part 32 completely by the force of the pressure spring 31. Preferably, the sliding part 30 is configured in U shape or cup shape, and nested into the holding part 32 with its opening coming first, wherein the pressure spring 31 supports itself against the bottom surface of the sliding part 30.

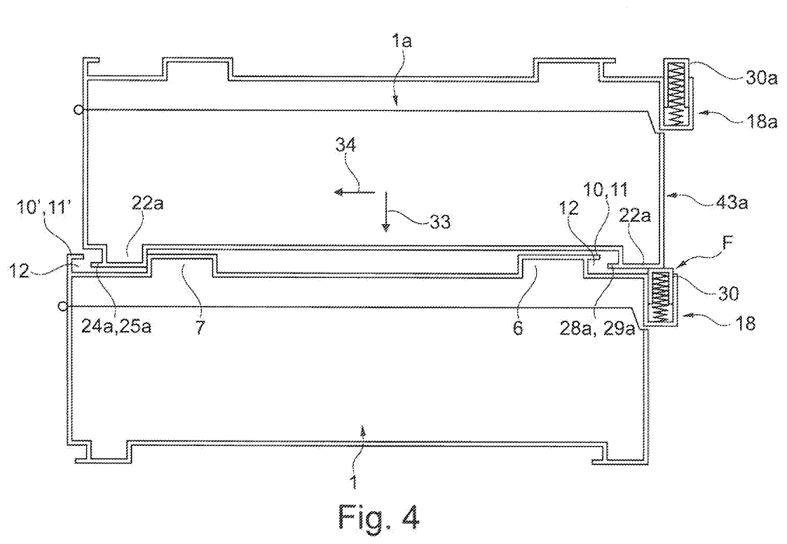

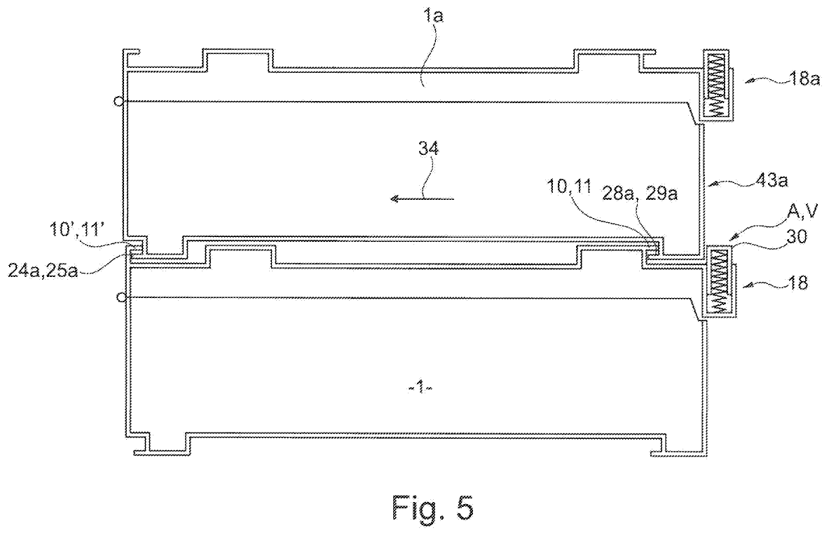

FIG. 3 shows a possible first assembly state with regard to stacking of the further box 1a on the box 1. FIG. 4 shows a possible second assembly state, and FIG. 5 shows a possible third assembly state. Components of the further box 1a that are identical with or have the same function as components of the box 1 are provided with the same reference symbols and the addition “a”. The further box 1a can be a box that has the same construction as the box 1.

In the first assembly state according to FIG. 3, the further box 1a has been brought into a position, relative to the box 1, so that the further box 1a can be set onto the contact surface 13 of the box 1 and the further box 1a is held in the receiving regions 8, 9. In order to allow the further box 1a to be set onto the box 1, the further box 1a is positioned, relative to the box 1, offset in the direction of the Y axis to such an extent that during a set-down movement in the direction of the arrow 33, a collision of the counter-coupling parts 28a, 29a, 24a, 25a of the further box 1 a with the coupling parts 10, 11, 10′, 11′ of the box 1 is prevented.

The locking element 18 still lies in its initial position A, in which it is situated in the receiving region 8 for the further box 1a. In the initial position A, the locking element 18 engages into a displacement path or a displacement segment W, over which the further box 1a must be displaced relative to the box 1, in order to arrive at formation of the plug-in connection—in the set-on state. In this regard, the locking element 18 assumes a blocking position S with regard to the displacement path W in the initial position A.

During the course of a set-down movement of the further box 1a in the direction of the arrow 33, activation of the locking element 18 by the further box 1a takes place, in that the further box 1a, for example with the one foot strip 22a, presses down on the locking element 18 and is moved out of the initial position A into the intermediate or end position, counter to the force of the pressure spring 31. In the intermediate or end position, the locking element 18 is situated in a release position F, in which the locking element 18 opens up the displacement path W, so that displacement of the further box 1a relative to the box 1, to form the plug-in connection, is permitted. In the second assembly state according to FIG. 4, the locking element 18 has been brought into the release position F by the further box 1a. Subsequently, the further box 1a is displaced, relative to the box 1, in the direction of the arrow 34, in other words in the Y direction, and the coupling parts 10, 11, 10′, 11′ of the box 1 are brought together or plugged into the counter-coupling parts 28a, 29a, 24a, 25a, forming the plug-in connection, in each instance. During the course of this displacement movement, the locking element 18 is released by the further box 1a, and automatically moves back due to the reset force of the pressure spring 31, preferably into the initial position A. In the reset position, in particular the initial position A, the locking element 18 assumes a locking position V in which the locking element 18 secures the plug-in connection to prevent it from moving apart or disengaging counter to the joining direction, in other words counter to the direction of the arrow 34. In the third assembly state according to FIG. 5, the boxes 1, 1a lie one on top of the other in the stacked state and with the plug-in connection having formed, wherein the locking element 18 has assumed the securing locking position V.

In the locking position V, the locking element 18 therefore serves as a stop for the further box 1a. On the further box 1a, the region of the front side 43a, for example, which can be offset toward the rear in the Y direction, for example, serves as a corresponding stop surface 20a. The carrying handle 19, as described in FIG. 1, can lie against this stop surface 20a or be guided on it.

During the course of the displacement movement of the further box 1a relative to the box 1 for forming the plug-in connection, the locking element 18 comes to lie against the stop surface 20a, for example. In the locking position V according to FIG. 5, the sliding part 30 therefore comes to lie against the front side 43a of the box 1a and secures the coupling connection between the boxes 1 and 1a to prevent unintentional disengagement.

In order to bring this coupling connection or plug-in connection out of engagement again, it is necessary, for example, to manually press the sliding part 30 downward, in order to bring the locking element 18 into the release position F according to FIG. 4. Then, the further box 1a can be displaced relative to the box 1, counter to the direction of the arrow 34, and thereby the existing engagement connection or plug-in connection can be opened.

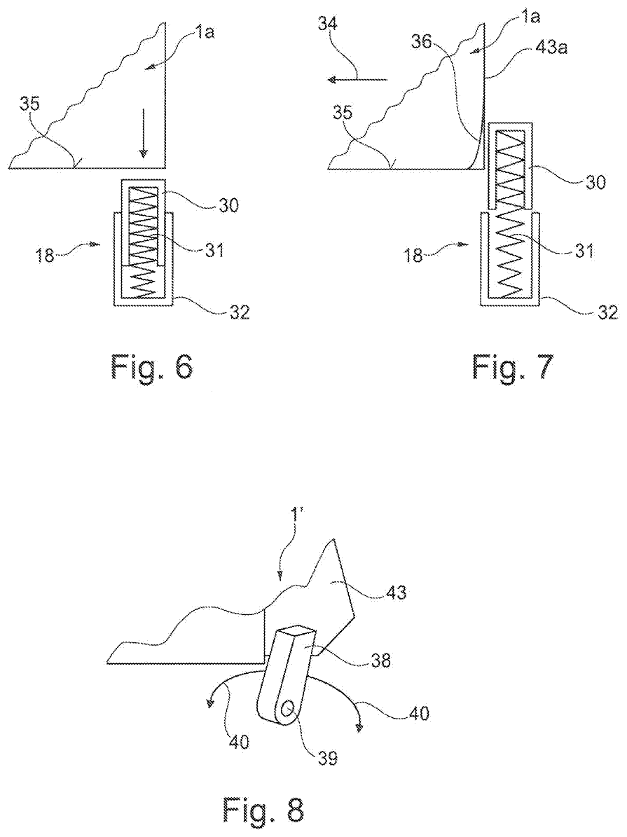

FIGS. 6 and 7 show an enlarged representation of the locking slider 18 of the box 1 together with a detail of the further box 1a. As is evident from FIG. 7, pre-tension of the plug-in connection or engagement connection can take place in that either the sliding part 30 and/or the front side 43a has/have related wedge surfaces 36 in the region where the sliding part 30 makes contact, in order to thereby additionally pre-tense the engagement connection or plug-in connection in the direction of the arrow 34. Pre-tension takes place with a spring load by means of the pressure spring 31. A bottom-side stop surface or activation surface 35 of the further box 1a can always be used as an activation surface for the locking element 18. However, the activation surface 35 is not necessarily a bottom surface. The activation surface 35 can be configured as an offset stop surface or the like, or as a foot strip or the like.

FIG. 8 shows a further embodiment of the box 1′ and of a locking element 38 in an enlarged representation. The locking element 38 is configured as a pivot lever there, which can be pivoted from the initial position A into the intermediate or end position about a pivot axle 39. The locking element 38 can be pivoted in the directions of the arrow 40 by means of the pivot axle 39. The pressure spring that is required for a spring pre-load is not shown.

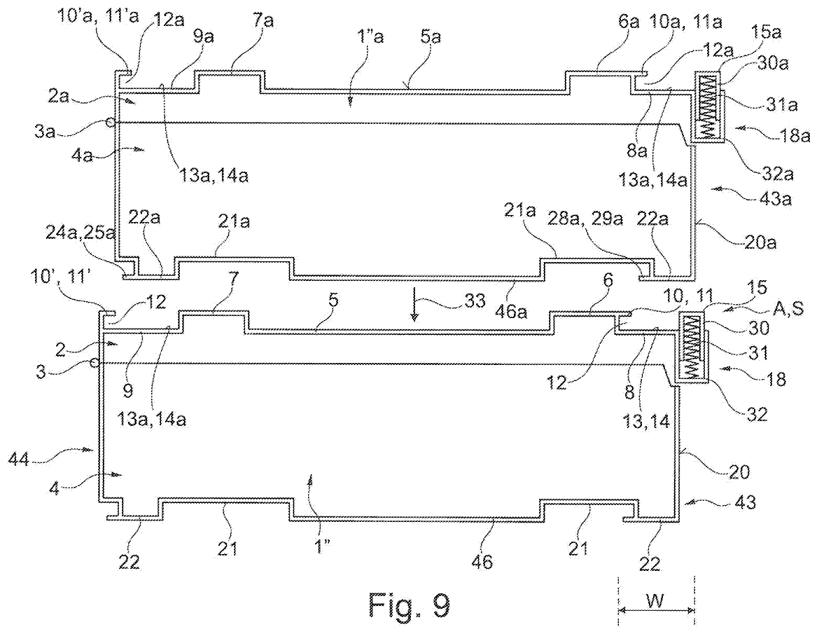

FIG. 9 shows yet another embodiment of a box 1″ with a further embodiment of a further box 1 a″. FIG. 9 is based on the representation in FIG. 2. The boxes 1″ and 1 a″ differ from the boxes 1 and 1a in that a projection 46 is provided on the bottom 42, which engages into the cross-groove 5 or is provided for engagement.

### REFERENCE SYMBOL LIST

1, 1a box
1′ box
1″, 1″a box
2, 2a lid
3, 3a hinge axle
4, 4a lower part
5, 5a cross-groove
6, 6a cross-rib
7, 7a cross-rib
8, 8a receiving region
9, 9a receiving region
10, 10a coupling part
11, 11a coupling part
10′, 10′a further coupling part
11′, 11′a further coupling part
12, 12a plug-in opening
13, 13a contact surface
14, 14a bottom surface
15, 15a end
16 closure element
17 recess
18, 18a locking element
19 carrying handle
20, 20a stop surface
21, 21a setback
22, 22a foot strip
23, 23a rear wall
24, 24a counter-coupling part
25, 25a counter-coupling part
28, 28a counter-coupling part
29, 29a counter-coupling part
30, 30a sliding part
31, 31a pressure spring
32, 32a holding part
33 arrow direction
34 arrow direction
35 activation surface
36 wedge surface
38 locking element
39 pivot axle
40 arrow direction
41 top
42 bottom
43, 43a front side
44 rear side
45 side surface
46, 46a projection
A initial position
S blocking position
F release position
V locking position
W displacement path

What is claimed is:

1. A stackable box, comprising:
a lower part;
a first foot strip arranged on an underside of the lower part;
a first projection extending from the first foot strip;
a second foot strip arranged on the underside of the lower part;
a second projection extending from the second foot strip;
a lid,
a first coupling part arranged on the lid directly above the first projection; and
a second coupling part arranged on the lid directly above the second projection.

2. The stackable box as in claim 1,
wherein the stackable box has a front and a rear, a distance from the front to the rear defining a longitudinal length of the box,
wherein the lid includes a first receiving region proximal to the first coupling part, the first receiving region having a longitudinal length which is greater than a longitudinal extension of the first foot strip.

3. The stackable box as in claim 2,
wherein the first receiving region is arranged in front of the first coupling part.

4. The stackable box as in claim 2,
wherein the first coupling part comprises a plug-in opening which is accessible from the front.

5. The stackable box as in claim 1,
further comprising a hinge which pivotally connects the lower part and the lid, the hinge being arranged at a rear of the box and having a transverse pivot axis.

6. The stackable box as in claim 1,
further comprising a vertically displaceable locking element arranged on a front side of the stackable box.

7. The stackable box as in claim 1,
further comprising a carrying handle pivotally connected to a front side of the lower part.

8. The stackable box as in claim 7,
wherein the carrying handle is arranged in a recessed portion of the front side of the lower part.

9. The stackable box as in claim 7,
further comprising a further carrying handle arranged on the lid.

10. The stackable box as in claim 1,
further comprising two latches which secure the lid to the lower part.

11. The stackable box as in claim 1,
wherein the first coupling part and the second coupling part are engagement tabs.

12. The stackable box as in claim 11,
wherein the engagement tabs are beveled.

13. The stackable box as in claim 1,
wherein the lower part comprises a carrying handle and
wherein the first coupling part and the second coupling part comprise openings facing a side of the box on which the carrying handle is arranged.

14. The stackable box as in claim 1,
further comprising a cross-rib extending across the lid and forming a rear stop of the first coupling part and the second coupling part.

15. The stackable box as in claim 1,
wherein the box is a storage box for tools.

16. A method for connecting two stackable boxes, comprising:
providing a lower box as in claim 1,
providing an upper box as in claim 1,
setting the upper box onto the lower box at a longitudinal offset so that the first foot strip of the upper box is arranged in front of the first coupling part of the lower box; and the second foot strip of the upper box is arranged in front of the second coupling part of the lower box; and
sliding the upper box backward so that the first projection of the upper box engages the first coupling part of the lower box and the second projection of the upper box engages the second coupling part of the lower box.
